(19) United States
(12) Patent Application Publication
(10) Pub. No.: US 2023/0418470 A1
(43) Pub. Date: Dec. 28, 2023

(54) DATA PROCESSING METHOD AND APPARATUS, AND ELECTRONIC DEVICE

(71) Applicant: LEMON INC., Grand Cayman (KY)

(72) Inventors: Liangchao WU, Beijing (CN); Junyuan XIE, Beijing (CN); Lizhe ZHANG, Beijing (CN); Di WU, Beijing (CN); Xiaobing LIU, Los Angeles, CA (US)

(21) Appl. No.: 18/252,982

(22) PCT Filed: Nov. 15, 2021
(86) PCT No.: PCT/SG2021/050700

§ 371 Date: May 15, 2023

(30) Foreign Application Priority Data
Nov. 16, 2020 (CN) 202011279842.7

(51) Int. Cl. G06F 3/06

(52) U.S. Cl. CPC G06F 3/0604; G06F 3/0638; G06F 3/0683

(57) ABSTRACT

Disclosed in the embodiments of the present disclosure are a data processing method and apparatus, and an electronic device. A specific implementation of the method comprises: determining a target first storage region from among a preset number of first storage regions; on the basis of a interaction process with a second device, determining identical target identification information comprised in the target first storage region and a target second storage region, and determining whether the interaction process meets a target requirement; and in response to the interaction process meeting the target requirement, storing target first data identified by the target identification information, so that the second device stores target second data identified by the target identification information. Thus, the target first data and the target second data identified by the same target identification information in the target first storage region and the target second storage region are aligned.

The present application claims the priority to Chinese Patent Application No. 202011279842.7, titled “DATA PROCESSING METHOD AND APPARATUS, AND ELECTRONIC DEVICE”, filed on Nov. 16, 2020 with the Chinese Patent Office, which is incorporated herein by reference in its entirety.

### FIELD

The present disclosure relates to the technical field of computers, and in particular to a data processing method, a data processing apparatus, and an electronic device.

### BACKGROUND

In daily life, the user may use Apps (Applications) to realize various functions, such as shopping functions, audio and video publishing functions, and evaluation information publishing functions.

Usually, user data may be generated in the user using an App. For example, in the user shopping by using an App, generated user data may include a price, the type, a brand and the like of an item purchased by the user.

In practice, the user data may be stored in a server for an App that the user is using.

### SUMMARY

The content part of the present disclosure is provided to introduce concepts in a brief form, and these concepts are to be described in detail in the following embodiments. The content of the present disclosure is not intended to identify the key features or essential features of the claimed technical solutions, nor is it intended to be used to limit the scope of the claimed technical solutions.

A data processing method, a data processing apparatus, and an electronic device are provided according to the embodiments of the present disclosure. With the present disclosure, target first data identified by target identification information in a target first storage area can be aligned with target second data identified by the same target identification information in a target second storage area.

In a first aspect, a data processing method is provided according to an embodiment of the present disclosure. The method includes: determining a target first storage area from a predetermined number of first storage areas, where identification information of each piece of first data in the first device is mapped to a first storage area in the predetermined number of first storage areas, and identification information of each piece of second data in a second device is mapped to a second storage area in a predetermined number of second storage areas; based on an interaction process with the second device, determining target identification information included both in the target first storage area and in a target second storage area and determining whether the interaction process meets a target requirement, where a storage area code of the target second storage area is same as a storage area code of the target first storage area; and in response to the interaction process meeting the target requirement, storing target first data identified by the target identification information, where the second device stores target second data identified by the target identification information.

In a second aspect, a data processing apparatus is provided according to an embodiment of the present disclosure. The apparatus includes: a first determination unit, a second determination unit, and a storage unit. The first determination unit is configured to determine a target first storage area from a predetermined number of first storage areas, where identification information of each piece of first data in the first device is mapped to a first storage area in the predetermined number of first storage areas, and identification information of each piece of second data in a second device is mapped to a second storage area in a predetermined number of second storage areas. The second determination unit is configured to, based on an interaction process with the second device, determine target identification information included both in the target first storage area and in a target second storage area and determine whether the interaction process meets a target requirement, where a storage area code of the target second storage area is same as a storage area code of the target first storage area. The storage unit is configured to, in response to the interaction process meeting the target requirement, store target first data identified by the target identification information, where the second device stores target second data identified by the target identification information.

In a third aspect, an electronic device is provided according to an embodiment of the present disclosure. The electronic device includes one or more processors and a memory. The memory stores one or more programs. The one or more programs, when executed by the one or more processors, causes the one or more processors to perform the data processing method provided in the first aspect.

In a fourth aspect, a computer-readable medium is provided according to an embodiment of the present disclosure. The computer-readable medium storage stores a computer program. The computer program, when executed by a processor, causes the processor to perform the data processing method provided in the first aspect.

With the data processing method, the data processing apparatus, and the electronic device according to the embodiments of the present disclosure, a target first storage area may be determined from a predetermined number of first storage areas. In practice, identification information of each piece of first data in the first device is mapped to a first storage area in the predetermined number of first storage areas, and identification information of each piece of second data in a second device is mapped to a second storage area in a predetermined number of second storage areas. Based on an interaction process with the second device, target identification information included both in the target first storage area and in a target second storage area is determined, and it is determined whether the interaction process meets a target requirement. In practice, a storage area code of the target second storage area is same as a storage area code of the target first storage area. In response to the interaction process meeting the target requirement, target first data identified by the target identification information may be stored, so that the second device stores target second data identified by the target identification information.

It should be understood that the first device stores the target first data and the second device stores the target second data. It indicates that in the first device and the second device, the target first data identified by target identification information in the target first storage area is aligned with the target second data identified by the same target identification information in the target second storage area. Thus, the first data in the first device is aligned with the second data in the second device without a third-party server.

In addition, the first data in the first device is aligned with the second data in the second device by aligning the target first data identified by target identification information in the target first storage area with the target second data identified by the same target identification information in the target second storage area. In practice, comparing to aligning a large amount of first data and second data, the workload of the first device and the second device can be reduced according to the present disclosure.

### BRIEF DESCRIPTION OF THE DRAWINGS

The above and other features, advantages and aspects of the embodiments of the present disclosure will be more apparent in conjunction with the accompanying drawings and with reference to the following embodiments. Throughout the drawings, the same or similar reference numerals represent the same or similar elements. It should be understood that the drawings are schematic and the originals and elements are unnecessarily drawn to scale.

FIG. 1 is a flow chart of a data processing method according to some embodiments of the present disclosure;

FIG. 2 is a sequence diagram of an interaction between a first device and a second device according to some embodiments of the present disclosure;

FIG. 3 is a sequence diagram of an interaction process between a first device and a second device according to some embodiments of the present disclosure;

FIG. 4 is a flow chart of determining whether an interaction process between a first device and a second device meets a target requirement according to some embodiments of the present disclosure;

FIG. 5 is a sequence diagram of an interaction between a first device and a second device according to some embodiments of the present disclosure;

FIG. 6 is a schematic structural diagram of a data processing apparatus according to some embodiments of the present disclosure;

FIG. 7 shows an exemplary system architecture to which a data processing method according to some embodiments of the present disclosure may be applied; and

FIG. 8 is a schematic structural diagram of an electronic device according to some embodiments of the present disclosure.

### DETAILED DESCRIPTION OF THE EMBODIMENTS

The embodiments of the present disclosure are described in detail below with reference to the accompanying drawings. Although the drawings show some embodiments of the present disclosure, it should be understood that the present disclosure can be implemented in various forms and is not limited to the embodiments. The embodiments are provided for a more thorough and complete understanding of the present disclosure. It should be understood that the drawings and the embodiments in the present disclosure are only illustrative of the disclosure, and are not intended to limit the protection scope of the present disclosure.

It should be understood that the steps of the method according to the embodiments of the present disclosure may be performed in different orders, and/or be performed in parallel. In addition, the method embodiments may include additional steps and/or omit to perform the illustrated steps, not limiting the scope of the present disclosure.

The term “including” and its variants as used herein are open-ended includes, that is, “including but not limited to”. The term “based on” means “based at least in part on.” The term “one embodiment” means “at least one embodiment”. The term “another embodiment” means “at least one additional embodiment”. The term “some embodiments” means “at least some embodiments”. Definitions of other terms are provided in the following description.

It should be noted that, the terms “first” “second” and so on mentioned in the present disclosure are only used to distinguishing different apparatuses, modules or units, rather than limit an order of functions performed by the apparatus, module or unit or limit interdependence.

It should be noted that, the terms “one” and “multiple” mentioned in the present disclosure are schematic rather than restrictive, and should be understood as “one or more” by those skilled in the art, otherwise explicitly illustrated in the context.

The names of messages or information exchanged between multiple devices in the embodiments of the present disclosure are only illustrative, and are not intended to limit the scope of the messages or information.

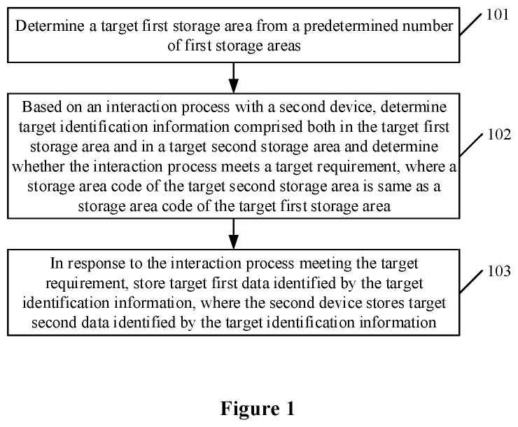

Reference is made to FIG. 1, which shows a flow chart of a data processing method according to some embodiments of the present disclosure. As shown in FIG. 1, the data processing method includes the following steps 101 to 103.

In step 101, a target first storage area is determined from a predetermined number of first storage areas.

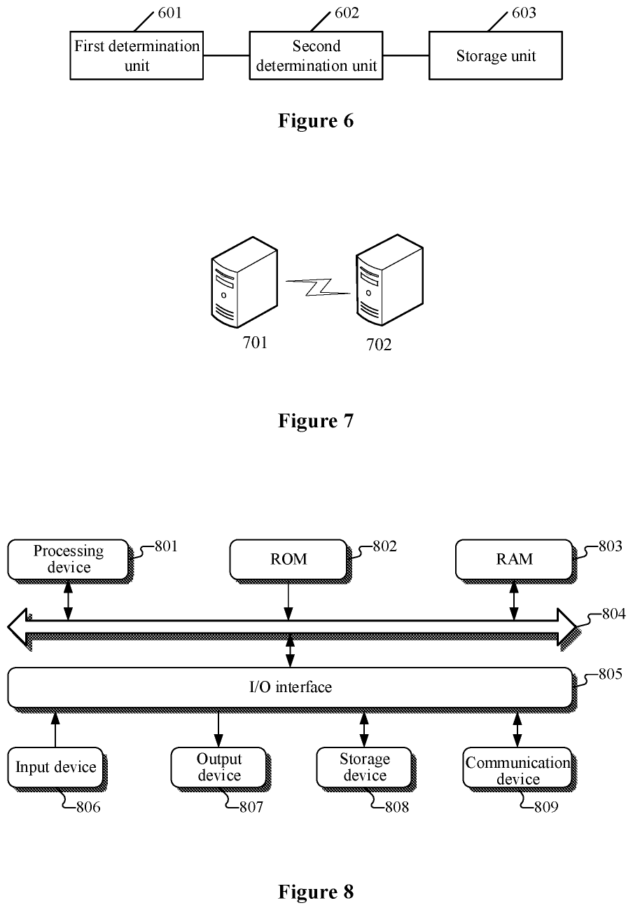

In the embodiment, the first device (such as a server 701 shown in FIG. 7) may determine a target first storage area from a predetermined number of first storage areas.

Identification information of each piece of first data in the first device is mapped to a first storage area in the predetermined number of first storage areas, and identification information of each piece of second data in a second device is mapped to a second storage area in a predetermined number of second storage areas.

The identification information is configured to identify a piece of first data or a piece of second data. In some scenarios, the first data and the second data may be user data. The identification information may be a phone number, an email address, or the like of the user.

In some scenarios, the first device may randomly select one of the predetermined number of first storage areas as the target first storage area.

In step 102, based on an interaction process with the second device, target identification information included both in the target first storage area and in a target second storage area is determined, and it is determined whether the interaction process meets a target requirement.

In the embodiment, the first device may determine the target identification information both included in the target first storage area and the target second storage area based on the interaction process with the second device.

A storage area code of the target second storage area is same as a storage area code of the target first storage area. It should be understood that the storage area code may be a code of a storage area. For example, the storage area code may be a natural number ranging from 0 to N.

In some scenarios, the first device may obtain identification information included in the target second storage area from the second device. Furthermore, the first device may obtain the target identification information both included in the target first storage area and in the target second storage area.

In the embodiment, the first device may, based on the interaction process with the second device, determine whether the interaction process meets a target requirement.

In some scenarios, the first device may determine the total number of identification information included in the target second storage area obtained from the second device. Furthermore, in response to the total number of identification information included in the target second storage area being less than a predetermined threshold, the first device may determine that the interaction process does not meet the target requirement.

In step 103, in response to the interaction process meeting the target requirement, target first data identified by the target identification information is stored, so that the second device stores target second data identified by the target identification information.

In the embodiment, in response to the interaction process meeting the target requirement, the first device may store the target first data identified by the target identification information.

In some scenarios, the first device may store the target first data identified by the target identification information in a local predetermined folder.

In the embodiment, in response to the interaction process meeting the target requirement, the second device may store the target second data identified by the target identification information.

In some scenarios, the first device may transmit the target information, indicating that the interaction process does not meet the target requirement, to the second device. Furthermore, in response to receiving the target information, the second device may store the target second data identified by the target identification information in a local predetermined folder.

According to the conventional technology, user data in a first server is aligning with user data in a second server through a third-party server, complicating the process of determining user data of a same user from both the first server and the second server, and increasing the cost of determining the user data of the same user from both the first server and the second server.

In the embodiment, the first device determines the target first storage area from the predetermined number of first storage areas. Then, based on the interaction process with the second device, the first device may determine the target identification information both included in the target first storage area and included in the target second storage area, and may determine whether the interaction process meets the target requirement. In response to the interaction process meeting the target requirement, the first device may store the target first data identified by the target identification information. The second device may store the target second data identified by the target identification information.

It should be understood that the first device stores the target first data and the second device store the target second data, which indicates that in the first device and the second device, the target first data identified by target identification information in the target first storage area is aligned with the target second data identified by the same target identification information in the target second storage area.

Thus, the first data in the first device is aligned with the second data in the second device without a third-party server.

In the embodiment, the identification information of each piece of the first data in the first device is mapped to a first storage area in the predetermined number of first storage areas. The identification information of each piece of the second data in the second device is mapped to a second storage area in the predetermined number of second storage areas.

Therefore, in a case that the amount of the first data and the amount of the second data are large, the identification information, having a small amount, of the first data may be mapped in the first storage areas, and the identification information, having a small amount, of the second data may be mapped in the second storage areas.

In addition, the first data in the first device is aligned with the second data in the second device by aligning the target first data identified by target identification information in the target first storage area with the target second data identified by the same target identification information in the target second storage area. In practice, comparing to aligning a large amount of first data and second data, the workload of the first device and the second device can be reduced according to the present disclosure.

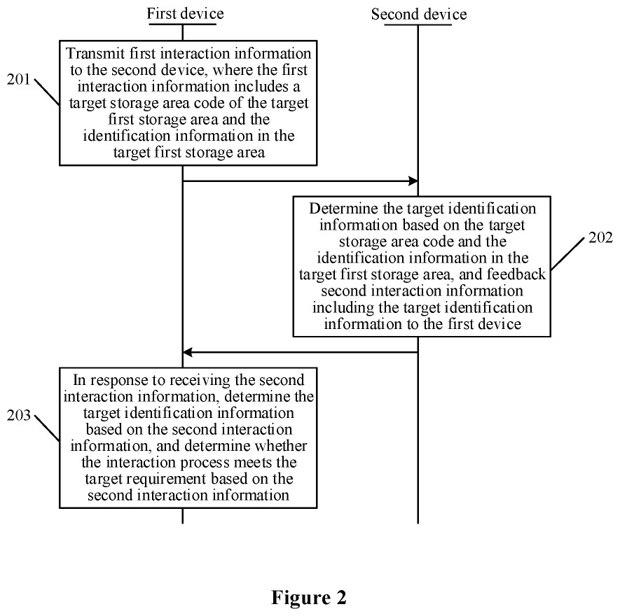

In some embodiments, the first device and the second device may interact with each other as shown in the sequence diagram in FIG. 2. In the sequence diagram shown in FIG. 2, steps 201, 202, and 203 are included.

In step 201, the first device transmits first interaction information to the second device.

The first interaction information includes a target storage area code of the target first storage area and the identification information in the target first storage area.

In step 202, the second device determines the target identification information based on the target storage area code and the identification information in the target first storage area, and feeds back second interaction information to the first device. The second interaction information includes the target identification information.

In some scenarios, the second device may determine a second storage area, having a storage area code being the target storage area code, as the target second storage area. Furthermore, the second device may determine identification information, which is also included in the target first storage area, from the target second storage area as the target identification information.

In practice, after determining the target identification information, the second device may feedback the second interaction information to the first device. The second interaction information includes the target identification information.

In step 203, in response to receiving the second interaction information, the first device determines the target identification information based on the second interaction information, and determines whether the interaction process meets the target requirement based on the second interaction information.

In practice, after receiving the second interaction information from the second device, the first device may directly obtain the target identification information from the second interaction information.

In some scenarios, in response to the total number of the target identification information included in the second interaction information exceeding the total number of the identification information included in the target first storage area, the first device may determine that the interaction process does not meet the target requirement.

Thus, the second device determines, based on the first interaction information received from the first device, the target identification information both included in the target first storage area and included in the target second storage area. Further, the first device determines, based on the second interaction information received from the second device, the target identification information. Then, the first device determines whether the interaction process meets the target requirement based on the second interaction information received from the second device.

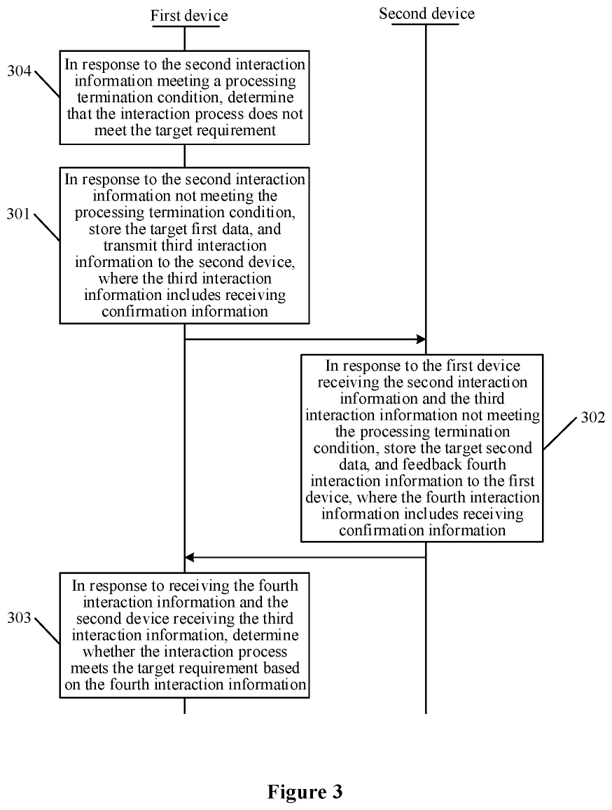

In some embodiments, the first device and the second device may interact with each other as shown in the sequence diagram in FIG. 3. In the sequence diagram shown in FIG. 3, steps 301, 302, and 303 are included.

In step 301, in response to the second interaction information not meeting a processing termination condition, the first device stores the target first data and transmits third interaction information to the second device.

It should be understood that the processing termination condition may be a condition in which processing performed on the target first storage area and the target second storage area is terminated.

In some scenarios, the processing termination condition may include a condition in which a time instant when interaction information in received is one or more predetermined time instants.

Thus, in a case that the second interaction information does not meet the processing termination condition, the first device may store the target first data identified by the target identification information.

The third interaction information includes receiving confirmation information. The receiving confirmation information may indicate that the first device has received the second interaction information.

Thus, in a case that the second interaction information does not meet the processing termination condition, the first device may feedback the third interaction information to the second device.

In step 302, in response to the first device receiving the second interaction information and the third interaction information not meeting the processing termination condition, the second device stores the target second data and feeds back fourth interaction information to the first device.

In practice, the second device may determine that the first device has received the second interaction information based on the receiving confirmation information included in the third interaction information.

Then, in a case that it is determined that the first device has received the second interaction information and the third interaction information does not meet the processing termination condition, the second device may store the target second data identified by the target identification information, and the second device may feedback the fourth interaction information to the first device.

The fourth interaction information includes receiving confirmation information. The receiving confirmation information may indicate that the second device has received the third interaction information.

In step 303, in response to receiving the fourth interaction information and the second device receiving the third interaction information, the first device determines whether the interaction process meets the target requirement based on the fourth interaction information.

In practice, the first device may determine that the second device has received the third interaction information based on the receiving confirmation information included in the fourth interaction information.

After determining that the second device has received the third interaction information, the first device may further determine whether the interaction process with the second device meets the target requirement based on the fourth interaction information.

In some scenarios, in response to a time instant when the fourth interaction information is received being a predetermined time instant, the first device may determine that the interaction process with the second device does not meet the target requirement. In response to a time instant when the fourth interaction information is received not being a predetermined time instant, the first device may determine that the interaction process with the second device meets the target requirement.

In some embodiments, step 304 may be further included in the sequence diagram shown in FIG. 3.

In step 304, in response to the second interaction information meeting the processing termination condition, the first device determines that the interaction process does not meet the target requirement.

Thus, in a case that the second interaction information meets the processing termination condition, the first device may determine that the interaction process with the second device does not meet the target requirement.

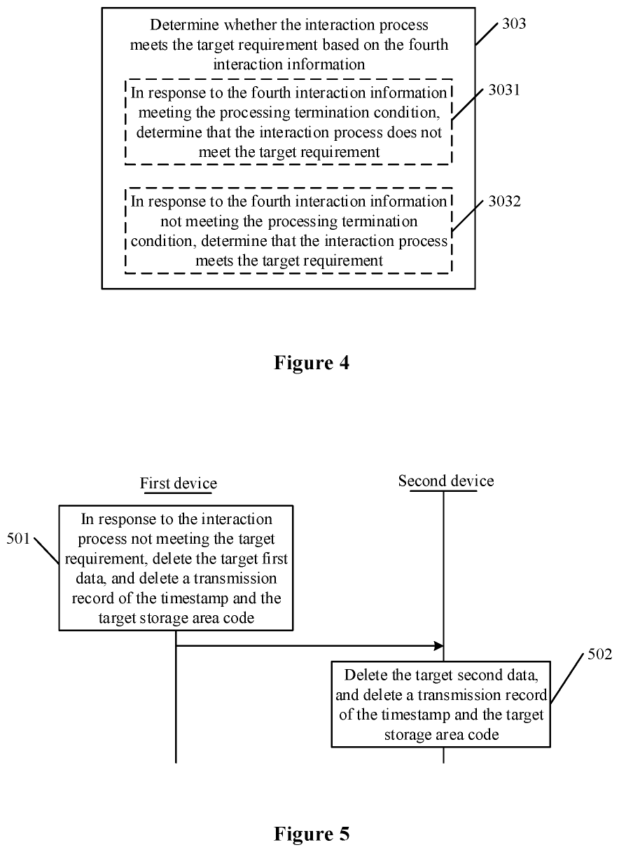

In some embodiments, the first device may perform the step 303 as shown in the flow chart in FIG. 4. In the flow chart, step 3031 is included.

In step 3031, in response to the fourth interaction information meeting the processing termination condition, it is determined that the interaction process does not meet the target requirement.

Thus, in a case of the fourth interaction information meeting the processing termination condition, the first device may determine that the interaction process with the second device does not meet the target requirement.

In some embodiments, in the flow chart shown in FIG. 4, step 3032 is further included.

In step 3032, in response to the fourth interaction information not meeting the processing termination condition, it is determined that the interaction process meets the target requirement.

Thus, in a case of the fourth interaction information not meeting the processing termination condition, the first device may determine that the interaction process with the second device meets the target requirement.

In some embodiments, the first interaction information further includes a timestamp. The timestamp indicates a time instant when the first device first transmits the target storage area code to the second device.

In practice, the time instant indicated by the timestamp may be understood as a time instant when the first device first transmits the target storage area code to the second device in performing processing on the target first storage area and the target second storage area.

The second interaction information, the third interaction information and the fourth interaction information further include the timestamp and the target storage area code.

In some embodiments, the processing termination condition includes at least one of: a condition in which a transmission record of the timestamp and the target storage area code does not exist, and a condition in which a waiting time period for receiving interaction information is longer than a predetermined time period.

The transmission record may be a record of transmitting the timestamp and the target storage area code.

As an example, after transmitting the first interaction information to the second device, the first device may store a transmission record of transmitting the timestamp and the target storage area code to the second device.

As another example, after receiving the first interaction information from the first device, the second device may extract the timestamp and the target storage area code included in the first interaction information. Further, the second device may feedback the second interaction information, including the timestamp, the target storage area code and the target identification information, to the first device. Moreover, the second device may store a transmission record of transmitting the timestamp and the target storage area code to the first device.

The reception waiting time period may be a time period from receiving interaction information to performing interaction.

As an example, the second device may determine a time period, from feeding back the second interaction information to receiving the third interaction information, as a reception waiting time period for the third interaction information.

As another example, the first device may determine a time period, from transmitting the first interaction information to receiving the second interaction information, as a reception waiting time period for the second interaction information.

As another example, the first device may determine a time period, from transmitting the third interaction information to receiving the fourth interaction information, as a reception waiting time period for the fourth interaction information.

In some embodiments, the first device and the second device may perform interaction as shown in the sequence diagram in FIG. 5. In the sequence diagram in FIG. 5, steps 501 and 502 are included.

In step 501, in response to the interaction process not meeting the target requirement, the first device deletes the target first data and deletes a transmission record of the timestamp and the target storage area code.

Referring to the above analysis, in a case that the second interaction information does not meet the processing termination condition, the first device may store the target first data identified by the target identification information. After transmitting the first interaction information to the second device, the first device may store a transmission record of transmitting the time stamp and the target storage area code to the second device.

Thus, in a case that it is determined that the interaction process with the second device does not meet the target requirement, the first device may delete the stored target first data and delete the transmission record of the timestamp and the target storage area code.

In step 502, the second device deletes the target second data and deletes a transmission record of the timestamp and the target storage area code.

Referring to the above analysis, in a case that the third interaction information does not meet the processing termination condition, the second device may store the target second data identified by the target identification information. After transmitting the second interaction information to the first device, the second device may store a transmission record of transmitting the time stamp and target storage area code to the first device.

In some scenarios, in a case of determining that the interaction process with the second device does not meet the target requirement, the first device may transmit a notification, indicating that the interaction process does not meet the target requirement, to the second device. Furthermore, the second device may delete the stored target second data and delete the transmission record of the timestamp and the target storage area code.

Thus, in performing processing on the target first storage area and the target second storage area, the data stored in the first device is kept consistent with the data stored in the second device.

In some embodiments, the first device may further perform the following steps.

Specifically, in response to the interaction process not meeting the target requirements, the first device transmits a request to the second device for processing the target first storage area and the target second storage area.

In practice, in a case that the interaction process between the first device and the second device does not meet the target requirement, the first device and the second device may determine that the processing performed on the target first storage area and target second storage area fails.

In a case that the processing performed on the target first storage area and target second storage area fails, processing may be performed again on the target first storage area and the target second storage area.

In some embodiments, the first device may perform step 101 as follows.

Specifically, the first device determines the target first storage area from the predetermined number of first storage areas in an order of storage area codes.

In practice, the first device may determine the target first storage area from the predetermined number of first storage areas in an order of storage area codes from small to large or from large to small.

Thus, in a certain order, processing is performed on the predetermined number of first storage areas and the predetermined number of second storage areas.

In some embodiments, for each piece of the first data, the first device may map the piece of first data to a corresponding first storage area by performing the following steps S1 and S2.

In step S1, a first result value is determined by processing identification information of the piece of first data by using a predetermined hash function.

Based on the predetermined hash function, a remainder of a hash value of the identification information over a sum of the predetermined number and 1.

For example, if the preset number is n, the identification information of the first data A is “123456”. The first result value T may be a remainder of a hash value of “123456” over “n+1”.

In step S2, the piece of first data is mapped to a first storage area with a storage area code equal to the first result value.

It should be understood that the first data A may be mapped to a first storage area with a storage area code of T.

Similarly, for each piece of the second data, the second device may map the piece of second data to a corresponding second storage area by performing the following steps L1 and L2.

In step L1, a second result value is determined by processing identification information of the piece of second data by using the predetermined hash function.

In step S2, the piece of second data is mapped to a second storage area with a storage area code equal to the second result value.

It should be noted that the way the second device performs steps L1 and L2 is similar to the way the first device performs steps S1 and S2, and is not repeated herein.

In practice, since the first device and the second device use the same hash function, the same identification information may be mapped to a first storage area and a second storage area that have a same storage area code in the first device and the second device respectively.

In some embodiments, first data and second data with same identification information obtained from a same user.

It can be seen that identification information of first data and second data obtained from a same user may be respectively mapped to a first storage area and a second storage area that have a same storage area code. For example, in a case that first data A and second data B are obtained from the user U, identification information of the first data A may be mapped to a first storage area having a storage area code M, and identification information of the second data B may be mapped to a second storage area having the same storage area code M.

It should be understood that the target identification information may be identification information of first data or and identification information of second data, where the first data and the second data are obtained from the same user. Therefore, that the first device stores the target first data and the second device stores the target second data indicates that the first device and the second device respectively store the target first data and the target second data from the same user. Thus, in the first device and the second device, the target first data and the target second data from the same user are aligned with each other.

Further referring to FIG. 6, as an implementation of the method shown in the above Figures, a data processing apparatus is provided according to some embodiments of the present disclosure. The apparatus embodiments correspond to the method embodiments shown in FIG. 1. The apparatus may be applied to various electronic devices.

As shown in FIG. 6, the data processing apparatus in the embodiment includes: a first determination unit 601, a second determination unit 602, and a storage unit 603. The first determination unit 601 is configured to determine a target first storage area from a predetermined number of first storage areas, where identification information of each piece of first data in the first device is mapped to a first storage area in the predetermined number of first storage areas, and identification information of each piece of second data in a second device is mapped to a second storage area in a predetermined number of second storage areas. The second determination unit 602 is configured to, based on an interaction process with the second device, determine target identification information included both in the target first storage area and in a target second storage area and determine whether the interaction process meets a target requirement, where a storage area code of the target second storage area is same as a storage area code of the target first storage area. The storage unit 603 is configured to, in response to the interaction process meeting the target requirement, store target first data identified by the target identification information, so that the second device stores target second data identified by the target identification information.

The specific processing and the corresponding technical effects of the first determination unit 601, the second determination unit 602, and the storage unit 603 of the data processing apparatus in the embodiment may refer to the descriptions of steps 101, 102, and 103 in the corresponding embodiments shown in FIG. 1, and are repeated herein.

In some embodiments, the second determination unit 602 is further configured to: transmit first interaction information to the second device, where the first interaction information includes a target storage area code of the target first storage area and the identification information in the target first storage area, then the second device determines the target identification information based on the target storage area code and the identification information in the target first storage area; feedback second interaction information including the target identification information to the first device; and in response to receiving the second interaction information, determine the target identification information based on the second interaction information and determine whether the interaction process meets the target requirement based on the second interaction information.

In some embodiments, the second determination unit 602 is further configured to: in response to the second interaction information not meeting a processing termination condition, store the target first data, and transmit third interaction information to the second device, where the third interaction information includes receiving confirmation information, and in response to the first device receiving the second interaction information and the third interaction information not meeting the processing termination condition, the second device stores the target second data and feedbacks fourth interaction information to the first device, and the fourth interaction information includes receiving confirmation information; and in response to receiving the fourth interaction information and the second device receiving the third interaction information, determine whether the interaction process meets the target requirement based on the fourth interaction information.

In some embodiments, the second determination unit 602 is further configured to: in response to the second interaction information meeting the processing termination condition, determine that the interaction process does not meet the target requirement.

In some embodiments, the second determination unit 602 is further configured to: in response to the fourth interaction information meeting the processing termination condition, determine that the interaction process does not meet the target requirement.

In some embodiments, the second determination unit 602 is further configured to: in response to the fourth interaction information not meeting the processing termination condition, determine that the interaction process meets the target requirement.

In some embodiments, the first interaction information further includes a timestamp. The timestamp indicates a time instant when the first device first transmits the target storage area code to the second device. The second interaction information, the third interaction information and the fourth interaction information further include the timestamp and the target storage area code.

In some embodiments, the processing termination condition includes at least one of a condition in which a transmission record of the timestamp and the target storage area code does not exist; and a condition in which a reception waiting time period for interaction information is longer than a predetermined time period.

In some embodiments, the data processing apparatus further includes a deletion unit (not shown in FIG. 6). The deletion unit is configured to: in response to the interaction process not meeting the target requirement, delete the target first data and delete a transmission record of the timestamp and the target storage area code. The second device deletes the target second data and deletes a transmission record of the timestamp and the target storage area code.

In some embodiments, the data processing apparatus further includes an initiating unit (not shown in FIG. 6). The initiating unit is configured to: in response to the interaction process not meeting the target requirement, transmit a request to the second device for processing the target first storage area and the target second storage area.

In some embodiments, the first determination unit 601 is further configured to: determine the target first storage area from the predetermined number of first storage areas in an order of storage area codes.

In some embodiments, for each piece of the first data, the first device maps the piece of first data to a first storage area by: determining a first result value by processing identification information of the piece of first data by using a predetermined hash function, where based on the predetermined hash function, a remainder of a hash value of the identification information over a sum of the predetermined number and 1; and mapping the piece of first data to a first storage area with a storage area code equal to the first result value.

For each piece of the second data, the second device maps the piece of second data to a second storage area by: determining a second result value by processing identification information of the piece of second data by using the predetermined hash function; and mapping the piece of second data to a second storage area with a storage area code equal to the second result value.

In some embodiments, first data and second data with same identification information obtained from a same user.

Reference is further made to FIG. 7, which shows an exemplary system architecture to which a data processing method according to some embodiments of the present disclosure may be applied.

As shown in FIG. 7, the system architecture may include a server 701 and a server 702. The server 701 may interact with the server 702 through a network. In practice, the network may include various types of connections, such as wired connection, wireless communication links, or fiber optic cables.

In some scenarios, the server 701 may be a server of a first application, and the server 702 may be a server of a second application.

The server 701 and the server 702 may be hardware or software. In a case that the server 701 and the server 702 are hardware, each of the server 701 and the server 702 may be implemented as a distributed server cluster including multiple servers, or may be implemented as a single server. In a case that the server 701 and the server 702 are software, each of the server 701 and the server 702 may be implemented as multiple software or software modules (such as multiple software or software modules for providing distributed services), or may be implemented as a single software or software module. There are no limitations herein.

In some scenarios, the server 701 may determine a target first storage area from a predetermined number of first storage areas. In practice, identification information of each piece of first data in the server 701 is mapped to a first storage area in the predetermined number of first storage areas. Identification information of each piece of second data in the server 702 is mapped to a second storage area in a predetermined number of second storage areas. Further, based on an interaction process with the second device, the server 701 may determine target identification information included both in the target first storage area and in a target second storage area, and determines whether the interaction process meets a target requirement. In practice, a storage area code of the target second storage area is same as a storage area code of the target first storage area. Furthermore, in response to the interaction process meeting the target requirement, the server 701 may store target first data identified by the target identification information. The server 702 may store target second data identified by the target identification information.

It should be noted that in some embodiments, the server 701 and the server 702 may be replaced with terminal devices, respectively.

In some embodiments, the data processing method according to the embodiments of the present disclosure may be performed by the server 701. Correspondingly, the data processing apparatus may be arranged in the server 701.

It should be understood that the number of the servers in FIG. 7 is only indicative. According to implementation requirements, any number of servers may be configured.

Hereinafter, reference is made to FIG. 8, which shows a schematic structural diagram of an electronic device (such as the server 701 in FIG. 7) suitable for implementing the embodiments of the present disclosure. The electronic device shown in FIG. 8 is only exemplary, and should not indicate any limitation to the function and application scope of the embodiments of the present disclosure.

As shown in FIG. 8, the electronic device may include a processing device 801 (such as a central processor and a graphics processor) which may execute various operations and processing through a program stored in a Read Only Memory (ROM) 802 or a program loaded from the storage device 808 into a Random Access Memory (RAM) 803. The RAM 803 is further configured to store various programs and data required by the electronic device. The processing device 801, the ROM 802 and the RAM 803 are connected to each other through a bus 804. An Input/output (I/O) interface 805 is also connected to the bus 804.

Generally, the I/O interface 805 may be connected to: an input device 806, such as a touch screen, a touch panel, a keyboard, a mouse, a camera, a microphone, an accelerometer, and a gyroscope; an output device 807, such as a liquid crystal display (LCD), a speaker, and a vibrator; a storage device 808 such as a magnetic tape and a hard disk; and a communication device 809. The communication device 809 enables the electronic device to perform wireless or wired communication with other devices for data exchanging. Although FIG. 8 shows an electronic device having various components, it should be understood that the illustrated components are not necessarily required to all be implemented or included. Alternatively, more or fewer components may be implemented or included. Each of boxes shown in FIG. 8 may represent one device or multiple devices according to requirements.

Particularly, according to some embodiments of the present disclosure, the process described above in conjunction with flow charts may be implemented as a computer program. For example, a computer program product is further provided in an embodiment in the present disclosure, including a computer program carried on a non-transitory computer readable storage medium. The computer program includes program codes for performing the method shown in the flow charts. In the embodiment, the computer program may be downloaded and installed from the network via the communication device 809, or installed from the storage device 808, or installed from the ROM 802. When the computer program is executed by the processing device 801, the above-mentioned functions defined in the method according to the embodiments of the present disclosure are performed.

It should be noted that, the computer readable medium mentioned herein may be a computer readable signal medium or a computer readable storage medium or any combination thereof. The computer readable storage medium may be, but is not limited to, a system, an apparatus, or a device in an electronic, magnetic, optical, electromagnetic, infrared, or semi-conductive form, or any combination thereof. The computer readable storage medium may be, but is not limited to, an electrical connection with one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), a light storage device, a magnetic storage device or any combination thereof. In some embodiments of the present disclosure, the computer readable storage medium may be any tangible medium containing or storing a program, and the program may be used by or in combination with an instruction execution system, apparatus, or device. In some embodiments of the present disclosure, the computer readable signal medium may be a data signal transmitted in a baseband or transmitted as a part of a carrier wave and carrying computer readable program codes. The transmitted data signal may be in various forms, including but not limited to an electromagnetic signal, an optical signal or any proper combination thereof. The computer readable signal medium may be any computer readable medium other than the computer readable storage medium and can send, propagate or transmit programs to be used by or with an instruction execution system, apparatus or device. The program codes stored in the computer readable medium may be transmitted via any proper medium including but not limited to: wired, optical fiber cable, radio frequency (RF), or any suitable combination of the foregoing.

In some embodiments, the client and the server may perform communication using any currently known or future developed network protocol such as HTTP (HyperText Transfer Protocol), and may be interconnected with any form or medium of digital data communication (for example, a communication network). The communication network embodiments include local area networks (“LANs”), wide area networks (“WANs”), internet, end-to-end networks (for example, ad hoc end-to-end networks), and any networks currently known or developed in the future.

The computer readable medium may be incorporated in the electronic device, or may exist independently without being assembled into the electronic device. The computer readable storage medium carries one or more programs. The one or more programs, when being executed by the electronic device, cause the electronic device to: determine a target first storage area from a predetermined number of first storage areas, where identification information of each piece of first data in the first device is mapped to a first storage area in the predetermined number of first storage areas, and identification information of each piece of second data in a second device is mapped to a second storage area in a predetermined number of second storage areas; based on an interaction process with the second device, determine target identification information included both in the target first storage area and in a target second storage area and determine whether the interaction process meets a target requirement, where a storage area code of the target second storage area is same as a storage area code of the target first storage area; and in response to the interaction process meeting the target requirement, store target first data identified by the target identification information, where the second device stores target second data identified by the target identification information.

Computer program code for performing operations of the present disclosure may be written in one or more programming languages, or a combination of the foregoing, and the programming language includes, but is not limited to, object oriented programming languages, such as Java, Smalltalk, and C++, also includes conventional procedural programming languages, such as “C” language or similar programming languages. The program codes may be executed entirely on a user's computer, or be executed partly on the user's computer, or be executed as a stand-alone software package, or be executed partly on the user's computer and partly on a remote computer, or be executed entirely on the remote computer or server. In a case that the execution of the program code involves a remote computer, the remote computer may be connected to a user's computer via any kind of network, including a local area network (LAN) or a wide area network (WAN), or may be connected to an external computer (for example, via an Internet providing by an Internet service provider).

The flow charts and block diagrams in the Figures shows the architecture, functionality and operation of possible implementations of the products of system, method and computer program product provided according to the embodiments of the present disclosure. Each block in the flow charts or block diagrams can represent a module, a program segment, or a part of code, and the module, the program segment, or the part of code includes one or more executable instructions for implementing specified logical functions. It should be noted that in some alternative implementations, the functions noted in the blocks may be implemented in a different order than those illustrated in the Figures. For example, two blocks shown in succession may in fact be executed substantially in parallel, and they may sometimes be executed in a reverse order, depending upon the functionality involved. It also should be noted that each block in the block diagrams and/or flow charts, and combinations of blocks in the block diagrams and/or flowcharts, can be implemented by a dedicated hardware-based system which is configured to implement specified functions or operations, or can be implemented by using a combination of dedicated hardware and computer instructions.

The units mentioned in the description of the embodiments of the present disclosure may be implemented by means of software, or otherwise by means of hardware. The names of the units do not constitute limitations on the units themselves. For example, the storage unit may also be described as “a unit for storing target first data identified by the target identification information in response to the interaction process meeting the target requirement, so that the second device stores target second data identified by the target identification information”.

The functions described above in this application may be performed at least in part by one or more hardware logic components. For example, without limitation, exemplary types of hardware logic components that can be used include: Field Programmable Gate Array (FPGA), Application Specific Integrated Circuit (ASIC), Application Specific Standard Product (ASSP), System on Chip (SOC), Complex Programmable Logical device (CPLD) and so on.

In the present disclosure, the computer-readable storage medium may be a tangible medium, which may contain or store a program used by the instruction execution system, apparatus, or device or a program used in combination with the instruction execution system, apparatus, or device. The computer-readable medium may be a machine-readable signal medium or a machine-readable storage medium. The computer-readable medium may include, but is not limited to, an electronic, magnetic, optical, electromagnetic, infrared, or semiconductor system, apparatus or device, or any suitable combination of thereof. The machine-readable storage media, for example, includes an electrical connection based on one or more wires, a portable computer disk, a hard drive, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of thereof.

The above description includes merely preferred embodiments of the present disclosure and explanations of technical principles used. Those skilled in the art should understand that the scope of the present disclosure is not limited to technical solutions formed by a specific combination of the above technical features, but covers other technical solutions formed by any combination of the above technical features or equivalent features thereof without departing from the concept of the present disclosure. For example, a technical solution formed by interchanging the above features with technical features having similar functions as disclosed (but not limited thereto) is also covered in the scope of the present disclosure.

In addition, although the operations are described in a specific order, it should not be understood that these operations are to be performed in the specific order shown or performed in a sequential order. Under certain circumstances, multitasking and parallel processing may be advantageous. Although the specific implementation details are described above, these implementation details should not be construed as limiting the scope of the present disclosure. The features described in multiple separate embodiments may be implemented in combination in a separate embodiment. Conversely, the features described in a separate embodiment may be implemented in multiple embodiments individually or in any suitable sub-combination.

Although the subject matter has been described in language specific to structural features and/or logical actions of the method, it should be understood that the subject matter defined in the appended claims are unnecessarily limited to the specific features or actions described above. The specific features and actions described above are merely exemplary forms of implementing the claims.

1. A data processing method, applied to a first device, wherein the method comprises:
determining a target first storage area from a predetermined number of first storage areas, wherein identification information of each piece of first data in the first device is mapped to a first storage area in the predetermined number of first storage areas, and identification information of each piece of second data in a second device is mapped to a second storage area in a predetermined number of second storage areas;
based on an interaction process with the second device, determining target identification information comprised both in the target first storage area and in a target second storage area and determining whether the interaction process meets a target requirement, wherein a storage area code of the target second storage area is same as a storage area code of the target first storage area; and
in response to the interaction process meeting the target requirement, storing target first data identified by the target identification information, wherein the second device stores target second data identified by the target identification information.

2. The method according to claim 1, wherein the determining target identification information comprised both in the target first storage area and in a target second storage area and determining whether the interaction process meets a target requirement comprises:
transmitting first interaction information to the second device, wherein the first interaction information comprises a target storage area code of the target first storage area and the identification information in the target first storage area, then the second device determines the target identification information based on the target storage area code and the identification information in the target first storage area, and feedbacks second interaction information comprising the target identification information to the first device; and
in response to receiving the second interaction information, determining the target identification information based on the second interaction information and determining whether the interaction process meets the target requirement based on the second interaction information.

3. The method according to claim 2, wherein the determining whether the interaction process meets the target requirement based on the second interaction information comprises:
in response to the second interaction information not meeting a processing termination condition, storing the target first data, and transmitting third interaction information to the second device, wherein the third interaction information comprises receiving confirmation information, wherein in response to the first device receiving the second interaction information and the third interaction information not meeting the processing termination condition, the second device stores the target second data and feedbacks fourth interaction information to the first device, and the fourth interaction information comprises receiving confirmation information; and
in response to receiving the fourth interaction information and the second device receiving the third interaction information, determining whether the interaction process meets the target requirement based on the fourth interaction information.

4. The method according to claim 3, wherein the determining whether the interaction process meets the target requirement based on the second interaction information further comprises:
in response to the second interaction information meeting the processing termination condition, determining that the interaction process does not meet the target requirement.

5. The method according to claim 3, wherein the determining whether the interaction process meets the target requirement based on the fourth interaction information comprises:
in response to the fourth interaction information meeting the processing termination condition, determining that the interaction process does not meet the target requirement.

6. The method according to claim 5, wherein the determining whether the interaction process meets the target requirement based on the fourth interaction information comprises:
in response to the fourth interaction information not meeting the processing termination condition, determining that the interaction process meets the target requirement.

7. The method according to claim 3, wherein
the first interaction information further comprises a timestamp, the timestamp indicates a time instant when the first device first transmits the target storage area code to the second device, and the second interaction information, the third interaction information and the fourth interaction information further comprise the timestamp and the target storage area code.

8. The method according to claim 7, wherein the processing termination condition comprises at least one of:
a condition in which a transmission record of the timestamp and the target storage area code does not exist; and
a condition in which a reception waiting time period for interaction information is longer than a predetermined time period.

9. The method according to claim 7, further comprising:
in response to the interaction process not meeting the target requirement, deleting the target first data, and deleting a transmission record of the timestamp and the target storage area code, wherein the second device deletes the target second data and deletes a transmission record of the timestamp and the target storage area code.

10. The method according to claim 7, further comprising:
in response to the interaction process not meeting the target requirement, transmitting a request to the second device for processing the target first storage area and the target second storage area.

11. The method according to claim 1, wherein the determining a target first storage area from a predetermined number of first storage areas comprises:
determining the target first storage area from the predetermined number of first storage areas in an order of storage area codes.

12. The method according to claim 1, wherein
for each piece of the first data, the first device maps the piece of first data to a first storage area by:
determining a first result value by processing identification information of the piece of first data by using a predetermined hash function, wherein based on the predetermined hash function, a remainder of a hash value of the identification information over a sum of the predetermined number and 1; and
mapping the piece of first data to a first storage area with a storage area code equal to the first result value; and
for each piece of the second data, the second device maps the piece of second data to a second storage area by:
determining a second result value by processing identification information of the piece of second data by using the predetermined hash function; and
mapping the piece of second data to a second storage area with a storage area code equal to the second result value.

13. The method according to claim 1, wherein first data and second data with same identification information obtained from a same user.

14. A data processing apparatus, applied to a first device, wherein the apparatus comprises:
at least one processor; and
at least one memory communicatively coupled to the at least one processor and storing instructions that upon execution by the at least one processor cause the apparatus to:
a determine a target first storage area from a predetermined number of first storage areas, wherein identification information of each piece of first data in the first device is mapped to a first storage area in the predetermined number of first storage areas, and identification information of each piece of second data in a second device is mapped to a second storage area in a predetermined number of second storage areas;
a based on an interaction process with the second device, determine target identification information comprised both in the target first storage area and in a target second storage area and determine whether the interaction process meets a target requirement, wherein a storage area code of the target second storage area is same as a storage area code of the target first storage area; and
a in response to the interaction process meeting the target requirement, store target first data identified by the target identification information, wherein the second device stores target second data identified by the target identification information.

15. (canceled)

16. A computer-readable medium, storing a computer program, wherein the computer program, when executed by a processor, causes the processor to perform the data processing method according to claim 1.
